(19) United States
(12) Patent Application Publication
(10) Pub. No.: US 2013/0098932 A1
(43) Pub. Date: Apr. 25, 2013

(54) DEVICE FOR ATTACHING TO A BABY BOTTLE FOR HOLDING THE BOTTLE

(71) Applicant: Cheryl S. Hunt, Raleigh, NC (US)

(72) Inventor: Cheryl S. Hunt, Raleigh, NC (US)

(21) Appl. No.: 13/277,426

(22) Filed: Oct. 20, 2011

(51) Int. Cl. A61J 9/06

(52) U.S. Cl. 220/772

(57) ABSTRACT

The present invention relates to a device for adding a pair of opposing handles removably to a baby bottle, comprising two D rings or other handles attached to a removable band.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to holding baby bottles. In particular, it relates to a device for attaching to a baby bottle for use by the baby to hold the bottle with both hands.

2. Description of Related Art

A baby bottle is generally a cylindrical container with a cylindrical body, neck portion and outfitted with a nipple to provide a means for the baby to suckle the contents of the bottle. The baby bottle, for all its positive attributes, is difficult for a baby to grasp when filled with whatever liquid is to be drunk. Typically, the bottle must be supported with help from a parent or the like or placed on a towel or other means of support. In addition, various bottle manufacturers have attempted to design the standard bottle so that it is adapted to be held easier by baby. Regardless of the shape, however, the bottle is usually too big for a baby to grasp firmly.

There have been various attempts at providing one or two handled bottles or in some cases, additional handles and the like, for the opportunity for baby to more easily hold the bottle. Devices which attach to the neck of the bottle which take advantage of the slope of the neck are known but generally they are too close to the nipple and do not work for most babies. Furthermore, they are not positionally adjustable and must rest in a single place. Single handle devices have been known since the mid 80's but the single handle devices are not sufficient for the bottle to be held, and as such, have not been utilized. For example, a single handled bottle holder is used which attaches via a C clamp which notably is only useful for single handle attachment.

The general approach to dual handled baby bottle design is to mold a bottle with the handles being an integral part of the bottle or to attach a device to the neck of the bottle. That allows for a very specific design to be supported by the permanent attachment to the bottle or attached high up on the bottle. In both cases its location cannot be adjusted. However, these designs do not take into account that a baby may have an ideal distance from their mouth that is most comfortable and this has been dealt with by creating heavy extra large handles that can be grasped anywhere but add to the cost and difficulty in manufacture and use of the handles. In U.S. Pat. No. 6,037,872 a pair of removable handles is shown, however, it requires that the bottle be adapted by molding modification to accept the handles. A bottle “off the shelf” cannot be used with the handles. The other problem is that when the baby grows, the baby outgrows the position of the handles, and a different bottle must be purchased with handles in a different position.

In spite of almost 25 years of various baby bottle handle adaptations being made there is still a need for a user of an unmodified bottle to be able to adapt a baby bottle such that it is convenient to use by a baby and yet still adjustable for the various arm lengths of individual babies.

### BRIEF SUMMARY OF THE INVENTION

The present invention solves the above problems that have existed for over 25 years within the art of baby bottle manufacturing by providing a pair of opposing baby handles separated by a circular attachment means which can be tightened circumferentially around the body of a baby bottle at a desired location distinct for each individual baby utilizing the device.

Accordingly, in one embodiment, the present invention relates to a device for removably attaching a pair of opposing handles to the body of a baby bottle of a size designed to be grasped by a baby and positioned on the body in a desired position along a length of the bottle body comprising:
a) a circumferential adjustable band for removably attaching to the body portion of a baby bottle;
b) a pair of baby grasping handles positioned about 180 degrees opposite each other on the adjustable band wherein the handles are positioned such that when the device is attached to a baby bottle the handles are parallel to the length of the bottle; and
c) wherein the handles are attached to the band in a balanced manner.

### BRIEF DESCRIPTION OF THE DRAWINGS

FIG. 1 is a frontal view of the D-handle device of the invention.

FIG. 2 is frontal view of the device on a baby bottle.

FIG. 3 is a frontal view of the device with multiple bands.

FIG. 4 is a frontal view of an open handle of the device on a baby bottle.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The term “about” as used herein means ±10%.

The term “substantially” as used herein means ±15%.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “baby bottle” refers to a essentially cylindrical container having a body portion, a neck portion, a top opening for placing liquid, and a cap fitted with an artificial nipple for attaching to the opening. Baby bottles with nipples are well known in the art. While several body designs are known, they are essentially all cylindrical with or without some form of body sideway tapering.

As used herein the term “handles” refers to a handle for being grasped by the hand of a baby or infant. Thus a “D” shaped handle, roughly the size of the baby's hand can be fashioned. Other shapes can be utilized as well, such as an open handle at the bottom. The D shape embodiment is more rigid and will be easier to utilize in the practice of some embodiments of the present invention. It will also be more stable when attached to the baby bottle and offer a more secure attachment place for the band utilized in the present invention. The handles are usually about two inches or less in height, but can be adapted to a particular baby's grip. Where a bottle is the regular bottle of four to six inches in length, the handles would represent less than half the length of the bottle's body. The handles can be made of any material compatible with babies and baby bottles. Typical embodiments of handles are plastic which are light weight and safe for babies. Other material, such as metals and the like, can be used with the limitation of weight and cost. The exact plastics and metals are within the skill of the art in view of the disclosure and figures herein.

The handles are attached to the band in a balanced manner that is distributed evenly between the top and bottom. For example, where one band is utilized, the band would be centered between the top and bottom of the handle (as opposed to attached only at the top of the handles). Where two or more bands are utilized, they would be distributed evenly between the top and bottom. The Figures illustrate this principle clearly and one skilled in the art can evenly distribute the handles on the band in view of the disclosure and figures.

In addition to even positioning in the attachment to the band, they are positioned on the band 180 degrees apart, that is, opposite one another as shown in the drawings. In addition, the handles are attached at substantially parallel to the length of the body rather than perpendicular or any other acute angle.

As use herein the phrase “circumferential adjustable band” refers to a circular band that fits around the circumference of the body of the baby bottle and firmly holds in place. The band must be easily attachable and removable and as such need not be utilized with a single bottle. Examples of adjustable bands include an elastomeric band that is slightly smaller than the circumference of the bottle body and can be stretched over the body to snuggly fit on the body. Another embodiment is a belt type band. A belt would be a circular band only when the buckle on the belt is closed to form a loop but that buckling would attach the belt to the bottle. Those skilled in the art can fashion an appropriate belt closure such as pant belt closure, Velcro hook and loop fasteners, and the like. One embodiment has a single belt, but two, three, four or more belts can be utilized. The belt can be as wide as desired from about a quarter of an inch to an inch or as big as the handle will allow. Where multiple bands are utilized each band can be the same or different.

The device of the present invention is attached to the bottle by engaging the belt on the body of the bottle in a position along the length of the bottle, the user determines the baby can best reach the handles. Where an elastomer is utilized, the band is stretched over the bottle body. Where a belt buckle band is utilized, the band is wrapped around the body and the belt buckled (and tightened with an adjustment means such as a series of holes and a pin or a belt slider device).

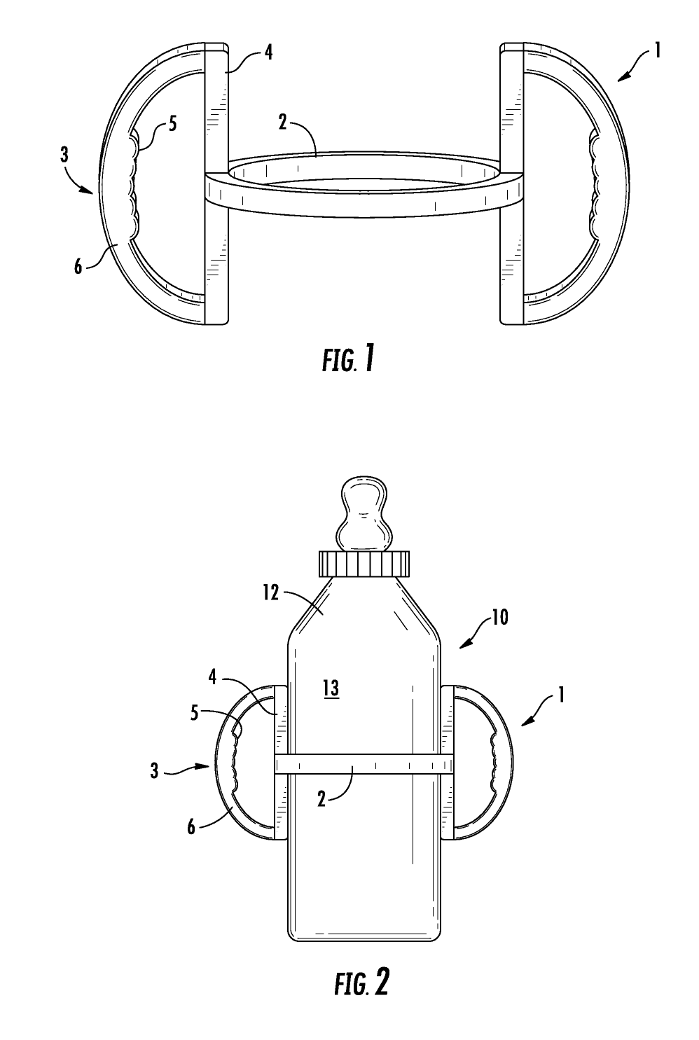

Now referring to the drawings. FIG. 1 is an embodiment of device 1 having a single band 2. The band 2 in this embodiment is an elastomeric band which has been attached to D handles 3 along the straight edge 4 of the D handles 3. The handles 3 show finger grabbing surface 5 along cured surface 6.

FIG. 2 is the device of FIG. 1 attached to a baby bottle. Bottle 10 has neck 12, and body 13. Elastomeric band 2 is stretched over body 13.

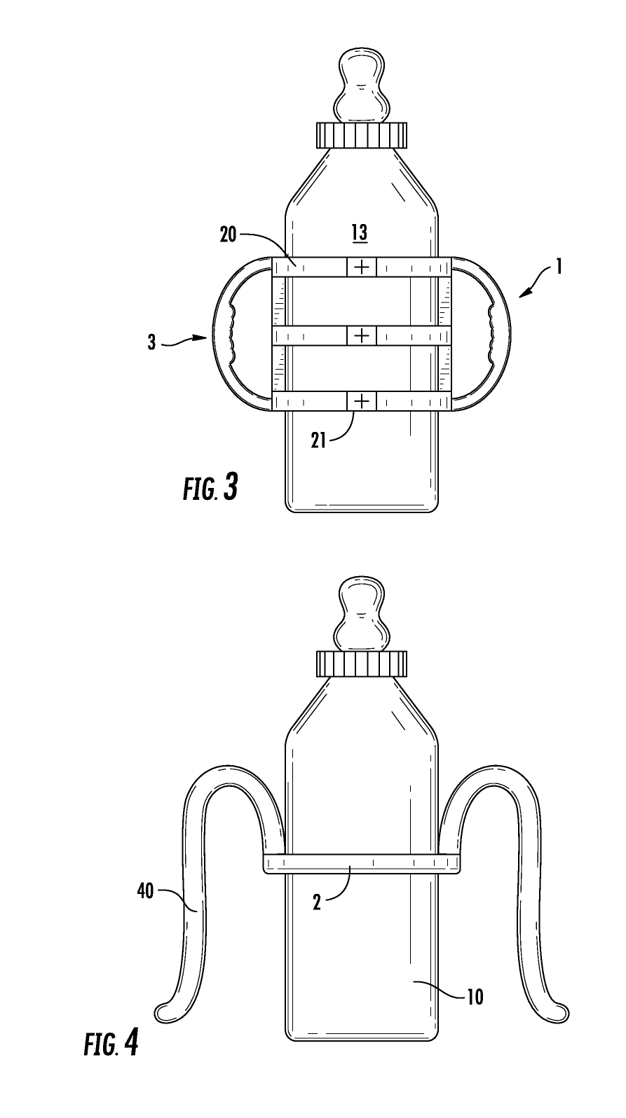

FIG. 3 shows a device with multiple bands 20 where each is a closure 21 type belt. The evenly spaced belts 20 are shown.

FIG. 4 is a frontal view of an open bottom handle. In this view open bottom handles 40 are attached to bottle 10 by an elastomeric band 2 in the same manner as the device in FIG. 2.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A device for removably attaching a pair of opposing handles to the body of a baby bottle of a size designed to be grasped by a baby and positioned on the body in a desired position along a length of the bottle body comprising:
a) a circumferential adjustable band for removably attaching to the body portion of a baby bottle;
b) a pair of baby grasping handles positioned about 180 degrees opposite each other on the adjustable band wherein the handles are positioned such that when the device is attached to a baby bottle the handles are parallel to the length of the bottle; and
c) wherein the handles are attached to the band in a balanced manner.

2. The device according to claim 1 wherein the band is an elastomeric band.

3. The device according to claim 1 wherein the band is an adjustable belt type band.

4. The device according to claim 1 wherein there are a plurality of circumferential adjustable bands each attached to the handles in the same manner.

5. The device according to claim 1 wherein the handles are D shaped or open bottom.

6. The device according to claim 1 wherein the handles have a height that is less than or equal to half the length of the bottle body.

7. The device according to claim 1 which has been removably mounted to the body of the baby bottle.

8. The device according to claim 1 wherein the belt has a closure.

9. The device according to claim 1 wherein there are three belts.

10. The device according to claim 1 wherein the belt is a elastomeric belt.
